(19) United States
(12) Patent Application Publication
(10) Pub. No.: US 2025/0273648 A1
(43) Pub. Date: Aug. 28, 2025

(54) BIO-DERIVED CARBON CERAMIC ELECTRODES

(71) Applicant: Dynamic Material Systems, LLC, Oviedo, FL (US)

(72) Inventors: William Easter, Chuluota, FL (US); Jonathan Frisch, Winter Springs, FL (US); Kyle Marcus, Oviedo, FL (US); Walter Sherwood, Ballston Lake, NY (US); Ryan Trammell, Oviedo, FL (US); Lauren Whetstone, Orlando, FL (US); Arnold Hill, Orlando, FL (US)

(21) Appl. No.: 19/057,162

(22) Filed: Feb. 19, 2025

Related U.S. Application Data
(60) Provisional application No. 63/557,545, filed on Feb. 25, 2024.

(51) Int. Cl. H01M 4/04; H01M 4/587

(52) U.S. Cl. CPC H01M 4/0471; H01M 4/587

(57) ABSTRACT

A composite electrode is made by combining a compatible polymer derived ceramic resin with a bioderived source of carbon and pyrolyzing the mixture. The resulting composite may be milled into a spherodized particulate powder and formed into an electrode of a battery with or without preionization of the electrode. For example, the bioderived source of carbon is selected from a polysaccharide.

### CROSS RELATED APPLICATIONS

This application claims priority to U.S. provisional 63/557,545, which was filed Feb. 25, 2025 which is cross-related to U.S. Provisional Application No. 62/861,036 filed Jun. 13, 2019, which is incorporated by reference in its entirety, U.S. application Ser. No. 16/543,130, PCT/US2019/46906, and copending U.S. application Ser. No. 17/941,697, which are both hereby incorporated by reference in their entirety herein.

### FIELD OF THE INVENTION

The field relates to electrodes for energy storage devices, especially ion batteries and capacitors.

### BACKGROUND

Higher energy density and power density are important for batteries to store electric energy for use when needed. There has been a dedicated effort to develop such batteries over several decades and many advances have been made. Regardless, more progress is needed before clean, renewable energy sources will be able to replace fossil fuels.

FCE % or First Cycle Efficiency is calculated from the initial Discharge Capacity divided by the initial Charge Capacity during the first cycle, which fraction is multiplied by 100 to arrive at a percentage. It is not a theoretical efficiency. It is an important characterization for an electrode. Performance at various charging and discharging rates is important for electrodes. The nomenclature for C/10, for example, means that the battery capacity is measured when the battery is discharged in 10 hours. The ability to survive a discharge in half an hour (2C) and still maintain a reasonable value for C/10 compared to an initial C/10 measurement is likewise an important characteristic for an ion battery. Impurities and imperfections are expected to greatly hinder the performance of electrodes in these tests, and the ability to compensate for impurities and imperfections without suffering failure is surprising and unexpected. The results reported herein are the measured averages for five charge discharge cycles at each reported rate.

One of the most accepted battery technologies is the lithium ion battery, and the most common lithium ion batteries are made with a graphite anode, lithium electrolytes, and a cathode which contains Li, such as LCO, LMO, NMC, LFP or NCA.

Graphite is used as an anode for some lithium ion batteries. Graphite provides acceptable electrochemical performance at lower cost than some competing materials. Graphite has a comparatively low volume expansion during charging and discharging compared to some other materials, and Graphite is abundantly available. The theoretical specific capacity of graphite is 372 mAh/g. Graphite electrodes (anodes in Li batteries) are known to be of moderate cost but suffer from only a moderate lifetime. Longer lifetimes are achieved using Li4Ti5O12 (LTO), for example; however, LTO electrodes cost much more and have a theoretical specific capacity of about 175 mAh/g, which is less than the theoretical specific gravity of Graphite.

There are tradeoffs that have driven continued research for better anodes. There has been much research into silicon anodes or electrodes due to greater theoretical density (e.g. 4200 mAh/g) or the addition of silicon to the anodes to improve lithiation. By adding silicon to Graphite or other materials it has been hoped that specific capacity of the anode could be increased. However, silicon expands and contracts during repeated charge and discharge cycles, as much as 300%, and battery lifetime (in cycles) is diminished unacceptably. Continued research to solve the expansion problem has been perceived as futile.

For example, a silicon oxycarbide glass-graphene composite paper electrode was prepared that achieved sufficiently long lifetime (1,020 cycles) at a mass loading of 2 milligram per square centimeter providing an electrode capacity of 588 milliAmp hour/gram. However, this anode degrades over time comparatively rapidly.

Silicon has received attention as a possible alternative to graphitic carbon, but it has significant disadvantages that remain to be overcome. A 320% crystoallographic expansion upon lithiation causes cracking, isolation and delamination issues, for example. In addition, stability issues remain, which affect cycling efficiency. The successful use of silicon and silicon composites have many challenges remaining, as stated in the first quarter progress report dated 2018 and entitled “Next Generation Anodes for Lithium-ion Batteries”.

Applicant discovered that an electrode of an energy storage device comprising a polymer derived ceramic coal dust composite provides unexpected and surprising results; however, sources for coal dust ultimately depend on the extraction of coal. Yet, many other sources do not perform as well as coal dust.

Since PDC resin derived ceramics, such as SiOC ceramics, are not inherently electrically conductive, absent coal dust, it is surprising and unexpected that a matrix of the material could become a better electrode than graphite or other materials, when combined with coal dust. However, Applicant wanted a renewable source of carbon that could work as well or better than coal dust. This proved to be challenging.

[Explain the challenge, failures, and or sweet spot for bio-derived material PDC composite electrodes.]

### SUMMARY

A bioderived carbon-polymer derived ceramic composite electrode comprises a bioderived carbon selected to be compatible with a polymer derived ceramic resin that, when mixed together and pyrolyzed, forms an electrically conductive ceramic composite for an electrode of a battery. Herein, “bioderived carbon” means a carbon material derived from a biological source and processed such that, when mixed with a selected polymer derived ceramic resin and pyrolyzed, mixture produces a SiOC ceramic composite material that, when milled to a powder, produces particulates having high specific surface area.

One advantage of a bio-derived carbon is the renewability of the carbon source; however, the trade-off is that bio-derived carbon sources are not known to achieve the same or better results compared to coal-derived carbon sources, such as coal dust. However, when processed, bioderived carbon sources surprisingly and unexpectedly achieve comparable results to coal dust as a composite electrode precursor.

To achieve performance the same or better than coal-derived sources of carbon, the bioderived carbon sources are processed differently. For example, the drying temperature and/or carbonization temperature of bioderived carbon sources are selected in order to result in porous graphitic carbon that yields SiOC composite structures having optimal specific surface area regions within an electrode fabricated using powders milled from the SiOC composite.

In one example, bio-derived sources of carbon achieve the same energy density and power density as coal-derived sources of carbon, such as carbon dust, when formed into electrodes. The polymer derived ceramic (PDC) precursor resin may be comprised of silicon, oxygen and carbon, for example. Many precursor resins are known to form ceramic materials through pyrolysis of inorganic preceramic polymer resin systems. PDC precursor resins may comprise silicon oxycarbide (SiOC), silicon carbon nitride (SiCN), silicon titanium oxycarbide, (Si—Ti—C-0), silicon aluminum oxycarbide (Si—Al—C-0), silicon-aluminum oxynitride (Si—Al—O—N), silicon carbide (SiC) and mixtures thereof. For example, bioderived carbon sources may be mixed with PDC resin selected from the PDC resin disclosed in copending U.S. application Ser. No. 17/941,697.

In one example, a bioderived carbon source is macerated. In another example, the bioderived carbon source is at least partially precarbonized bioderived carbon. In one example, a resulting bioderived carbon and polymer derived ceramic composite is formed, milled into powder and prelithiated as one step in the process of forming an anode of a lithium ion battery. For example, a resulting composite electrode comprises silicon and carbon atoms in a structure that provides a composite, electrically conductive electrode with activated sites for attachment of lithium ions, especially useful as an anode in a lithium ion battery. However, the same composite electrode may be useful in a sodium ion battery with a pre-sodiation process substituting for a pre-lithiation process. Other types of ion batteries that would benefit from the unique ability to resist degradation from repeated cycling, high specific surface area and atomically robust association of chemically bound silicon and carbon atoms within a composite structure may be formed from the same particulates with or without a process similar to prelithiation. In one example, liathiation may occur by precycling the anode through repeated charge-discharge cycles with or without subsequently reforming the anode into a production battery.

Previously, applicant made electrodes using other sources of carbon such as contaminated graphite and coal dust. These performed surprisingly well when compared with pure, synthetic graphite. Apparently, these sources of carbon benefitted from some impurities remaining in the source of carbon that resulted in better properties. Now, renewable, bio-derived sources of carbon have been incorporated, successfully, into high performance composite electrodes without using difficult processes for purification of all impurities.

In one example, polysaccharides were prepared as a source of carbon for combination with polymer derived ceramic (PDC) resin. The polysaccharide derived carbon is processed such that, when mixed with the PDC resin and pyrolyzed, the mixture forms a ceramic composite material. The ceramic composite material may be milled into a powder that may be formed into an electrode of a battery. The results of this combination are surprising and unexpected, as the polysaccharides utilized do not have the hydrocarbon impurities that were believed to benefit the electrodes made when coal dust and PDC resin were combined, for example.

Instead, the processing of the polysaccharide derived carbon is thought to result in a similar microstructural carbon precursor with a preferable high specific surface area of the microstructural carbon precursor prior to mixing the carbon precursor and the PDC resin.

Another advantage of using bioderived carbon sources is that the bioderived carbon sources may be waste products that would otherwise incur costs for disposal of the waste products, such as husks and the like. Therefore, use of these bioderived carbon sources for forming battery electrodes may benefit the commercialization of other processes that would not otherwise be commercially practical, such as production of renewable energy or the like. Alternatively, the use of bioderived carbon sources may reduce the cost of other processes such as food production/processing.

### BRIEF DESCRIPTION OF THE DRAWINGS

The following drawings are illustrative examples and do not further limit any claims that may eventually be issued.

FIG. 1 illustrates an example of a particle size distribution for a compatible PDC resin.

FIG. 2 compares A) non-spherodized particles with B) spherodized particles for the resin in FIG. 1.

FIG. 3 compares resulting voltage-specific capacity results for non-spherodized (milled) particles in FIG. 2A with spherodized particles shown in FIG. 2B.

FIG. 4 compares specific capacity measured at standard cycle numbers in a cell for three different electrodes made with a non-spherical particle and two spherical particles with differing cure temperatures.

FIG. 5 compares electrode performance for spherodized particle electrodes.

FIG. 6 illustrates a flow diagram for creating composite particles having a spherical shape.

FIG. 7 illustrates an example of a cross section of a particle coated by a polymer derived ceramic precursor.

FIG. 8 illustrates an example of carbon particles in PDC resin spherical composite particle prior to pyrolysis.

FIG. 9 illustrates another example of carbon particles in PDC resin spherical composite particle prior to pyrolysis.

FIG. 10 compares polysaccharide sources for carbon in carbon-PDC composite particle electrodes.

When the same reference characters are used, these labels refer to similar parts in the examples illustrated in the drawings.

### DETAILED DESCRIPTION

Bioderived sources of carbon are structurally varied and contain organic and inorganic constituents that vary, and not all bioderived sources are equal when utilized for making electrodes suitable for use in batteries, such as lithium ion batteries.

Structural and electrochemical properties of the resulting ceramic dramatically affect the resulting properties, which have been optimized by the methods recited in applicant's inventions. A method of carbonization, activation and doping may be utilized with bioderived sources of carbon for electrodes made by reacting the bioderived sources of carbon with PDC resin. In one example, preprocessing steps are performed on the bioderived sources of carbon that lead to better electrochemical performance when electrodes are made in a pyrolysis reaction with the bioderived sources of carbon and PDC resin. The resulting properties are influenced by the following factors: structure and morphology; degree of graphitization; chemical composition; chemical composition; decontamination; process of synthesis; and mechanical stability.

Structure and Morphology. The structure and morphology of a carbon source impacts the performance of an electrode. For example, increasing specific surface area of carbon sources while maintaining uniformity and spacing of porous structures within a carbon source may result in a preferred ceramic pore structure following pyrolysis of the carbon source in intimate contact within a mixture with a PDC resin, resulting in more active sites for ion adsorption and facilitating more rapid ion diffusion within an anode used in a battery. Pore size distributions in carbon source materials are thought to impact electrochemical performance of electrodes made using such carbon precursors. For example, it is thought that this makes some bioderived sources better than others, leading to improved battery performance when carbon sources have optimal pore structures. In one example, the processing of polysaccharides results in a preferably polysaccharide derived carbon source when the polysaccharide derived carbon source is preprocessed, milled and mixed with a compatible PDC resin prior to pyrolysis, post-pyrolysis milling and forming of an electrode, with or without prelithiation.

Graphitic Conversion. Bioderived carbon sources may yield more or less graphitic carbon. It is thought, without being limiting, that a higher degree of graphitization of the bioderived carbon sources tends to exhibit better conductivity within an electrode. Improved conductivity makes electron transfer during charge-discharge cycles more efficient. Also, graphitic carbon sources may offer a more stable structure and may better accommodate volume changes, all else being the same, as volume changes inevitably occur during ion intercalation and deintercalation.

Chemical Composition. Chemical composition of carbon sources affect electrochemical properties of electrodes made from the carbon sources. It is thought, without being limiting, that oxygen-containing functional groups, such as hydroxyl, carbonyl, and carboxyl groups, may alter the surface chemistry of an electrode made using carbon sources containing these oxygen-containing groups increasing both ion storage capacity and cycling stability. For example, polysaccharide carbon sources are thought to form and retain these types of groups when processed as carbon sources and mixed with a PDC resin and pyrolyzed.

Decontamination. The presence of some other impurities or contaminants are known to negatively impact electrochemical performance of electrodes. Purification or decontamination of carbon sources may be necessary to remove certain contaminants that impair performance, if possible. Alternatively, certain bioderived carbon sources that limit these harmful contaminants may enhance electrochemical properties of electrodes made with the bioderived sources of carbon.

Process of Synthesis. The method used to prepare a bioderived source of carbon may greatly influence its structure, morphology, chemistry and electrochemical properties. Hydrothermal carbonization, pyrolysis, and chemical activation may be used in the synthesis of bioderived sources of carbon that improve the properties of resulting electrodes.

Mechanical Stability. The mechanical stability of the bioderived carbon within an electrode is important for the electrode to withstand volume changes that occur during charge-discharge cycles. Good mechanical stability may result in structural integrity over multiple cycles, resulting in improved cycling stability and longer battery lifespan.

In one example, selection and optimization of bioderived sources of carbon for composite lithium-ion battery anodes yields surprising and unexpected results. For example, mass loss during pyrolysis of a bioderived source of carbon mixed with a PDC resin, resulting in a SiOC composite material, has been determined to correlate with specific capacity rate performance, irreversible loss or first cycle efficiency, and average potential. For example, lower mass loss is observed during pyrolysis of a 75 wt % SiOC PDC+25 wt % prepyrolized BIOCHAR, which tends to have lower first lithiation specific capacity, lower FCE, lower average potential, and higher rate performance at 1C and 2C. In another example, utilizing 75 wt % SiOC PDC+25 wt % CORN HUSK that is preheated only to drying temperature, and not prepyrolyzed to biochar, a greater mass loss during pyrolysis is observed, after combining with the PDC resin, which resulted in a higher first lithiation specific capacity, higher FCE, higher average potential, and lower rate performance at 1C and 2C. However, better performance is the result of morphological and structural aspects that impact the performance of electrodes made from bioderived sources of carbon, rather than simply being a product of mass loss. Thus, the preprocessing of the source of bioderived carbon, prior to mixing with the PDC resin, is important, and the preprocessing of sources of bioderived carbon is not the same as the preprocessing steps utilized with coal dust, for example, if the use of the bioderived carbon sources is to be successful.

Processing Examples. Sources of bioderived carbon may be milled and processed to produce a bioderived carbon source using the following process, for example: The source may dry at a drying temperature, such as a drying temperature selected from 90C to 150C under vacuum, removing residual moisture. Alternatively, a drying/carbonization temperature or temperatures may be selected. For example, a pre-carbonization temperature may be selected from 600C to 1600C (under vacuum or low oxygen content atmosphere) removing some organic matter and activating carbon materials through restructuring of carbon surface chemistries, for example. Selecting a higher drying/carbonization temperature may have an effect on surface area, particle size, carbon structure (i.e. Hard or Soft Graphatizable carbons) and surface features of the resulting source of carbon. Subsequent combination, later, with a PDC resin may be the same for comparison purposes.

In one example, a polysaccharide carbon source precursor is dried in a range from 90 to 150C to remove residual moisture and is carbonized in a range from 600-1600C. For example, the polysaccharide may comprise corn husks, rice husks or the like. More preferably, a drying temperature may be selected from 100 to 120C and Carbonizing may be performed from 700-1300C. For example, drying may be performed at about 110C and carbonizing may be performed by holding at a temperature within a range from 800-1000C.

For example, dried and/or dried/carbonized bioderived sources of carbon may be milled to a fine powder, such as by mechanical milling. Alternatively, a macerating process may be utilized that both chops and mills a bioderived source of carbon for use in electrodes.

The milled powder may be sieved to select powder sized from 5 microns to 90 microns. Preferably, the size of powders is selected to be less than 32 microns. In one example, the powders are sieved to select powders having a particle size of about 5 microns with less than 10percent of the powder particles greater than 5 microns.

The sieved material may be mixed with a PDC resin, such as the PDC resins described in copending application U.S. application Ser. No. 17/941,697. The mixture may be a slurry of PDC resin and powder particles, and the slurry may be cured under an inert gas for at least twenty minutes at 90C. Alternatively, the slurry may be cured for 60 min at 230C. In one example, the curing is defined as “soft curing” at a temperature from 90C to 150C for a duration from 20 minutes to 1 hour. Alternatively, the curing may be defined as “hard curing” defined as a temperature from 150C to 400C for a duration from 20 minutes to 2 hours. The curing atmosphere may include gases such as Argon, Nitrogen, Open Air, or other gases.

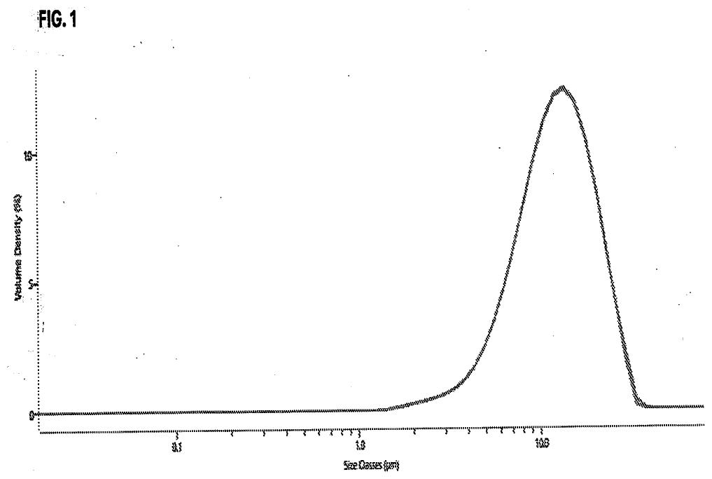

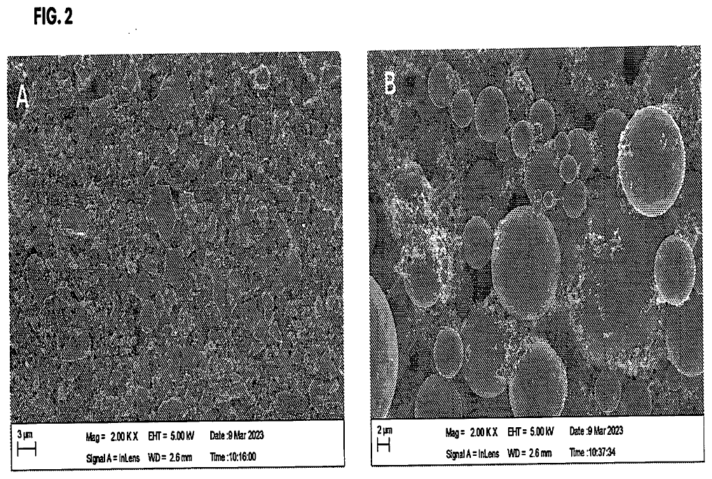

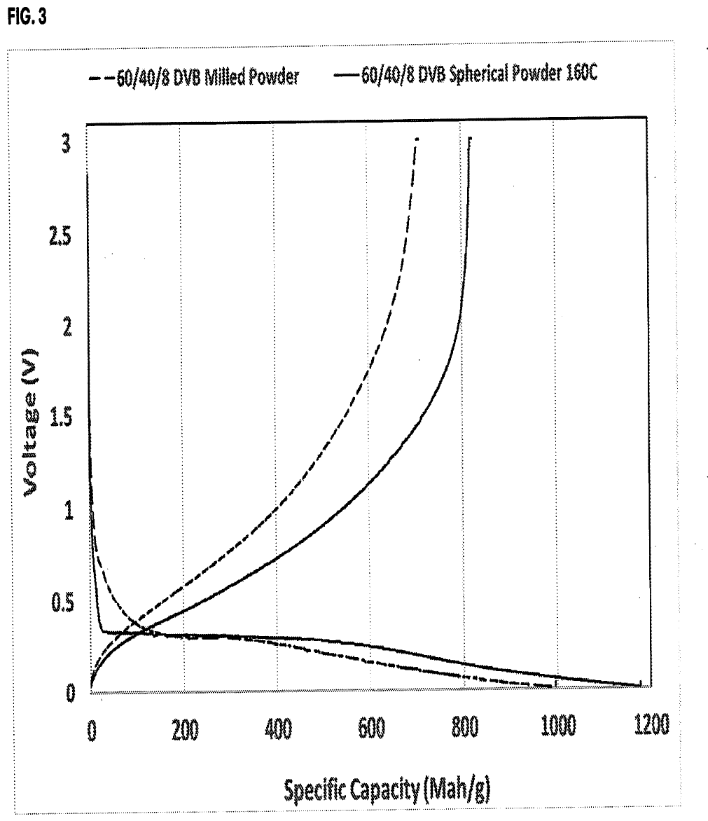

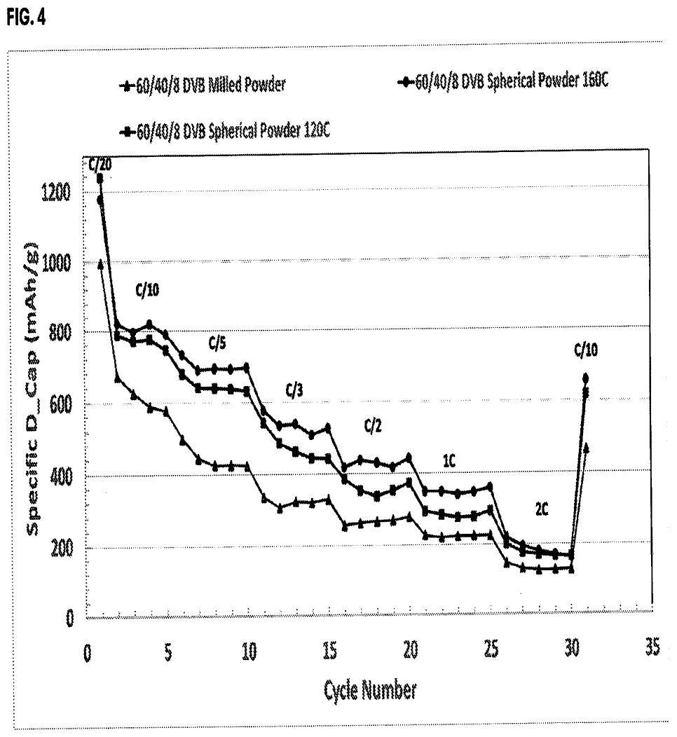

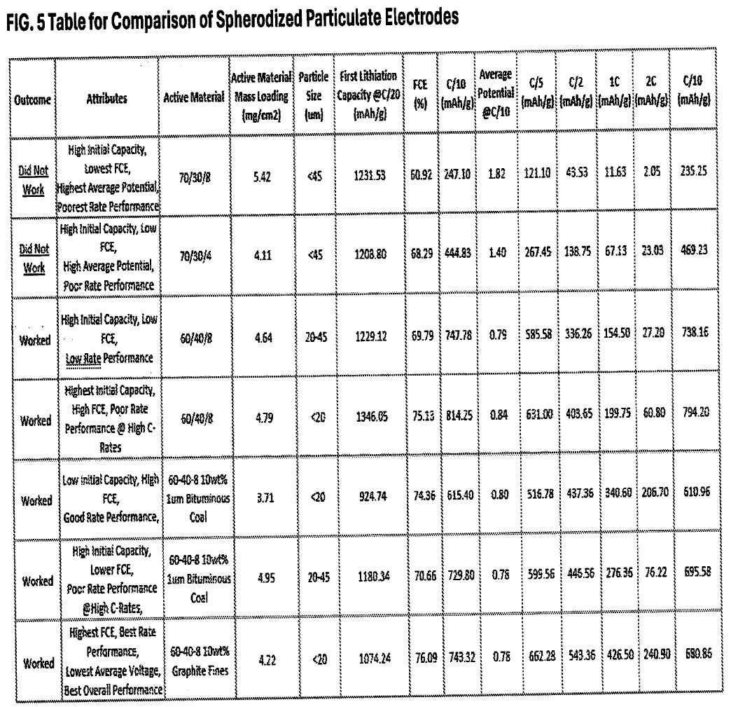

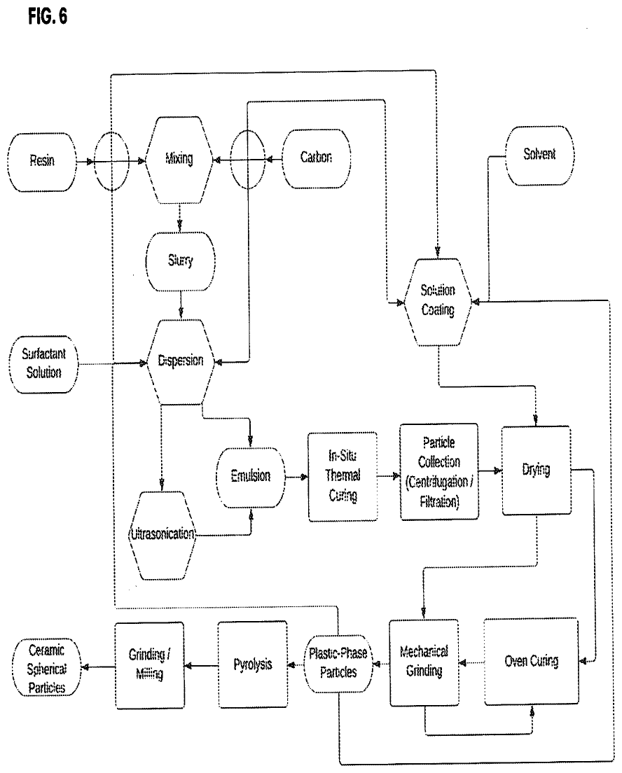

In FIG. 1, a particle size distribution is shown for SiOC spherodized particles formed from a 60/40/8 resin example comprising 60 parts Methyl Hydrogen Silicone fluid with 40 parts Dicyclopentadiene and 8 parts per hundred resin (phr) of divinylbenzene added. In FIG. 2, the morphological differences are compared between electrodes made of particles produced A) using known milling processes to B) spherodized particles. FIG. 3 illustrates benefits of spherodization in the resulting performance of electrodes made of the respective particles. FIG. 4 shows a half cell cycling comparison between spherodized particles cured at 120 and 160 degrees centigrade to a non-spherodized example. Both of the spherodized examples significantly outperform the non-spherodized control. FIG. 5 provides a compilation of results for spherodized particle electrodes. Spherodization of composite particles may proceed using an emulsification and curing process, as illustrated in the process flow diagram of FIG. 6, for example. After curing, for example, the cured mixture may be milled, again, such as by mechanically milling. For example, milling may be performed in a coffee grinder, jet mill, roller mill, attritor mill, pin mill, ball mill, pulverizer, burr grinder, or the like, resulting in a cured powder with spherodized particles when compared to the previously known milling processes. The cured powder may have a D100 particle size. For example, the cured powder may be sieved at a particle size less than 90 microns, more preferably less than 45 microns, even more preferably less than 32 microns. The resulting modification to morphology and performance are striking, as evidence in FIG. 4, for example.

In FIG. 5, tabular results are provided for electrodes made from spherodized particles. The 60/40/8 PDC resin is compared to two other resins: 70/30/4 and 70/30/8, which comprise 70 parts Methyl Hydrogen Silicone fluid with 30 parts Dicyclopentadiene and either 4 or 8 per hundred resin (phr) Divinylbenzene, respectively. The 60/40/8 PDC resin works for electrodes and benefits from combination with unexpected sources of carbon including: coal (lignite, sub bituminous, bituminous, anthracite), coal waste products, coal tar pitch, coal byproducts, graphene, graphitic carbons, amorphous carbons (soft, hard), carbides, carbon fibers, carbon nanomaterials, biobased carbons from Green waste, Food waste, Municipal waste, Crop residues, Farm residues, Wood biomass, Industrial byproducts, sawdust, wood chips, lawn clippings, palm leaves, biosolids, manure, biochar, algal biomass, aquatic plants, spent coffee grinds (SCG), rice straw, rice husks, Corn stover (corn husks, corn stalks, corn cobs), distiller grains, glycerol (byproduct of biodiesel), bagasse (pulp from sugar cane), nut shells (pistachio, peanut), okara (the waste product from soy milk/tofu), oat pulp (from oat milk), fruit casing and pits, vegetable peelings, bamboo waste, paper mill waste, brewery wastes (spent grain, hot tub), waste cotton, food soiled paper products (pizza boxes, napkins, etc). More preferably, bioderived carbon provides a renewable source of carbon for carbon-PDC electrodes when the particles are spherodized. Even more preferably, the bioderived carbon is a polysaccharide derived carbon comprising one or a combination of the following sources of carbon: starch, cellulose, alginate, pectin, algar, carrageenan, gums, bacterial polysaccharides, fungal polysaccharides and animal polysaccharides.

Pyrolysis. The cured powder may be pyrolyzed under low oxygen to oxygen free environment at a pyrolysis temperature. For example, the temperature may be 1000C, and the temperature may be raised at a ramp rate of 1C/min, followed by a temperature hold at the 1000C pyrolysis temperature for one hour. Other pyrolysis temperatures may be chosen, but the pyrolysis temperature of 1000C is an example used for some polysaccharide carbon sources after being mixed with a compatible PDC resin. Following pyrolysis, a ceramic resultant from chemical reactions that occur during pyrolysis may be passively cooled to room temperature. The chemical reactions that occur include reactions that the PDC resin undergoes to form a ceramic, reactions that the source of carbon undergoes that results in outgassing, reactions between the PDC resin and the source of carbon, and reactions from impurities that are included in the source of carbon depending on its source. The pyrolysis atmosphere may include Argon, Nitrogen, CO/CO2 blends, Argon/Hydrogen blends, or other gases. In some examples, a reducing atmosphere, such as Argon/Hydrogen, benefits the composite particles, resulting in an activated surfaces on and within the particles for pre-ionization of the active surfaces. In alternative embodiments the ramp rate for pyrolysis may be selected from 0.2-10C/min or more preferably 0.5-5C/min. For example, the ramp rate may be selected from 1-2C/min. While about 1000C may be preferred for the hold temperature for some materials, the hold temperature may be selected from 800-1400C or more preferably 900-1200C. In one example, the hold temperature is selected in a range from 1000-1100C. This paragraph serves as the definition for pyrolysis for this application.

Milling. After pyrolysis, the resulting ceramic composite may be milled into a fine powder, such as by planetary ball milling. Other powder milling and sizing methods may include jet milling, roller milling, attritor milling, pin milling, pulverizer, burr grinder, or the like. Milling may include other processes, such as ultrasonication, before, during or after milling, which serve to separate particles. This paragraph serves as the definition for milling in this application.

Sieving. The milled ceramic composite material may be sieved to a preferred particle size. The particle size may be selected as a D100 Particle Size, more preferably less than 45 microns, or even more preferably less than 20 microns. for example, a particle size less than 18 microns may be selected for use in forming an anode for a lithium ion battery. Alternatively, the particle size may be selected as a D50 Particle Size Range, more preferably in a range from 5-20 microns, even more preferably in a range from 5-10 microns and/or 15-20 microns. In one example, the particle size is selected in a range from 6-8 microns and/or 16-18 microns. Two different particle size ranges may be combined for selected particle packing morphologies, for example. This paragraph serves as the definition of sieving in this application and includes all of the known processes for particle separation by size whether achieved using settling, a centrifuge, or any other process of separating particles into different size categories.

Drying. The sieved particles may be dried in a vacuum oven until dry. Drying may be performed over several hours or overnight. Alternatively, drying may be performed in air at ambient temperature and pressure. Herein, drying is performed at a temperature less than 400 degrees centigrade and is not a part of the process of pyrolysis. Instead, the purpose of drying is to remove some or all of a solvent or water from a substance. If heating is used during drying, the temperature for heating is held at a temperature above the ambient temperature, preferably at or above 90 degrees centigrade, if drying a slurry that is water based. The temperature and pressure for drying depends on the solvent and the length of time desired for completing the process of drying. This paragraph serves as the definition of drying in this application. Materials that state “predried” were dried at a temperature from 90 and 150 degrees centigrade. Materials that state “precarbonized” were processed beyond the drying step at elevated temperatures above 400 degrees centigrade.

Solution Polymerization. In one example, a method for producing an anode starts with solution polymerization. In one example, an amount of surface area is selectively controlled by mascerating [or other milling processing] bio-derived carbon precursors and mixing the resulting particulates with compatible PDC precursors to coat the particulates in the PDC precursor resins. A catalyst and solvent are added and a temperature may be selected to in situ polymerize the PDC precursor resins during the solution polymerization process. Then, the resulting polymer-carbon mixture may be pyrolyzed and milled to a powder. Alternatively, a step of ball milling, crushing, pulverizing or grinding may be used in the milling/mascerating processes, before or after adding a PDC precursor resin. By solution polymerization, a compatible PDC may be optimized for bioderived carbon sources, such as polysaccharide carbon sources.

For example, the chemistry of a PDC precursor resin may be selected to be as shown in the comparative results of FIG. 5, for example. In one example, the electrochemical behavior was influenced by the selected chemistry improving capacity, charge/discharge rate capability, long-term stability, cycle life, nominal voltage and charge transfer behavior of a battery cell compared to the other chemistries tested. Usually, a change in chemistry may improve one of these while degrading the performance of others, with trade-offs being inevitable. Bioderived carbon sources, especially polysaccharide derived carbon sources, when added to compatible PDC resins, spherodized and pyrolyzed, achieve a surprising and unexpected improvement in these results similar to coal dust. These bioderived sources of carbon are renewable and offer a way to use what would otherwise be considered waste. The bioderived sources perform better if predried without pre-pyrolysis of the bioderived sources of carbon. Thus, the source of carbon provides an advantage that is particularly unexpected given normal expectations for such waste with its expected impurities.

In another example, other silicon based materials such as SiOx, SiO2, Si, and metals such as cobalt, nickel, manganese, magnesium, sodium, lithium, titanium, tin, potassium, calcium, copper, aluminum, germanium, vanadium, and non-metals such as sulfur, phosphorus, boron, chlorine, bromine, fluorine, oxygen, and nitrogen and molecules containing these, may be added before pyrolysis. For example, the PDC resin may be modified to enhance performance in particular ion batteries. Electrochemical modification by the PDC resin can also be used to optimize interactions with electrolytes and other cell components or interfaces, for example. In one example, a bioderived carbon-PDC resin component is blended with other active materials: such as other PDC resins before or after the pyrolysis of the other PDC resins, and/or with battery grade active materials, forming a multi-slurry system. Examples include the addition of a battery grade natural and/or synthetic graphite blended with PDC particles, for example.

Preionization methods. Preionization methods may be selected from known processes such as Synthesis Prelithiation, Electrochemical Prelithiation, Direct Chemical Prelithiation, and Lithium Doping Pretreatment Methods, for example. Preionization is a term adopted herein to refer to the prelithiation, presoidation, and the like, which add active ions of the type being used in a particular battery cell chemistry.

Cell chemistries. Chemistries may include, but are not limited to, lithium ion, sodium ion, potassium ion, magnesium ion, zinc manganese oxide, magnesium lithium, lithium sulfur, lithium metal, solid state, lead-acid, nickel-cadmium, metal-air, sodium sulfur, liquid metal, anode free, sodium metal halide, vanadium redox flow, and zinc polyiodide flow.

Capacitor Electrode. Also, in one alternative example, a composite electrode, which is made of a bioderived carbon and PDC resin that is spherodized, pyrolyzed and formed into an electrode, may be used in a capacitor, which does not benefit from preionization.

Example. In one example, a process produces spherical particles by dispersing a pre-ceramic polymer resin in a solution of 2% surfactant, such as Triton X-100, and deionized water. The dilute pre-ceramic polymer is added in an amount that is 10-20% by weight of the amount of surfactant solution, for example. Then, the dilute pre-ceramic polymer resin may be mixed with up to 25% by weight of particles, such as bio-derived carbon or pre-carbon particles to form a slurry. Alternatively, the slurry may be formed between the particles and the pre-ceramic polymer resins prior to adding the slurry to the aqueous surfactant solution. In one alternative, the bio-derived carbon particles may be suspended in the aqueous surfactant solution first before mixing the pre-ceramic polymer resins with the suspended bio-derived carbon particles. In another alternative, the pre-ceramic polymer resin and bio-derived carbon particles are added to the aqueous surfactant solution separately but may dispersed at the same time within the solution. The resulting dispersion may be subjected to an emulsification process such as by high-shear dispersion blade or impeller and/or sonication, such as ultrasonication. The emulsion forms spherical resin or resin/carbon droplets suspended in aqueous surfactant solution. In one example, using ultrasonication above 20 kHz of the emulsion/pre-emulsion, further reduces droplet size and improves the ultimate electrode performance, particularly if a second spheroidization process is used, such as by adding an additional outer coating to the particles.

Thermal Curing. After an emulsion is formed, temperature of the emulsion may be increased to 35-40 degrees centigrade, initiating a first thermal curing. The solution may be held at temperature for 2-24 hours to allow for gelation, while continuously stirring the emulsion. Then, the emulsion may be cooled to ambient temperature (or lower) and allowed to set for up to 12 hours, more preferable up to 8 hours, until particles settle out of the aqueous solution, for example. This settling is a first separation process. Then, the remaining aqueous solution may be decanted and the larger, settled-out particles may be collected and dried. The decanted aqueous solution may comprise smaller, unsettled particles, and these smaller particles may be collected by centrifugation, filtration, and/or evaporation of the liquid, a second separation process. Following separation/collection, the dried particles may undergo a second curing step in an oven at an elevated temperature, such as a temperature selected from 120 to 160 degrees centigrade, such as in air or an inert atmosphere. Then, the particles may be ground, crushed, or otherwise subjected to a process that reduces agglomeration or separates the particles into single, spherical plastic-phase particles, which plastic-phase may undergo pyrolysis in an inert-atmosphere or non-oxidizing atmosphere to convert the plastic phase particles to a hard, ceramic phase. The hard, ceramic phase may be further separated, by grinding, milling or otherwise, to break up agglomerates that formed during pyrolysis, resulting in ceramic-phase sphericalized particles.

Particle Thin Coating Version 1. Inorganic polymer resin is first dispersed in a solvent or blend of solvents such as acetone, alcohol, and/or water to form a dilute solution of 5-10% by weight of resin in solvent. This solution is then introduced to carbon particles at an amount that is 20-60% of the weight of the carbon particles.

Particle Thin Coating Version 2. Carbon particles are first combined with the solvent to form a slurry. Polymer resin is then dispersed into the solvent/carbon particle slurry.

Particle Thin Coating Version 3. Inorganic polymer resin and carbon particles are dispersed in the solvent simultaneously.

General Methodology. The inorganic polymer resin, solvent, and carbon particles are thoroughly mixed until all carbon particles are wet with solution. The slurry is placed in a sealed container and left to sit for 8-24 hours. The slurry is then transferred to a tray or other open container and dried. Drying/evaporation of the solvent can be done in an ambient environment, an oven, or by any other drying method. Following drying, the particles are subjected to mechanical grinding in a coffee grinder-type milling machine to break up any agglomerates/fused particles. The objective is to obtain singular carbon particles with a thin coating of polymer resin, for example, which may be utilized as is or may be spherodized in a subsequent spherodization process. Coated carbon particles may undergo a thermal treatment at 110-160 degrees centigrade in an oven to cure the resin coating. This can be done in an inert or air atmosphere. Following curing, the particles are subjected to mechanical grinding in a coffee grinder-type milling machine to break up any agglomerates/fused particles they may have formed during curing. The desired result is singular carbon particles with a thin coating of cured, plastic-phase polymer. The plastic-phased-coated particles may be subjected to pyrolysis to convert the carbon-plastic-phase polymer to a ceramic composite or may be cycled back into the spherical particle production process, with the plastic-phase polymer serving as an adhesion promoter to improve incorporation of carbon particles into more spherical, pre-ceramic resin particles. Results show that this subsequent spheroidization is preferred for electrode materials. The particle thin coating and spherical particle production methods can be employed in conjunction to create multilayer-coated carbon particles. Thin-coated carbon particles can also undergo further thin coating processes to create multilayer thin-coatings.

Synthesis Preionization. Synthesis preionization may be used for integration of ionic species, such as lithium, into a composite particle electrode system prior to curing or pyrolysis, for example. For example, lithium salts, such as Lithium Chloride, Lithium Bromide, Lithium Fluoride, Lithium Carbonate, Lithium Nitrate, Lithium Sulfate, Lithium Sulfide, Lithium Perchlorate, Lithium Citrate, Lithium Methoxide, and Lithium Chlorate, may be added to prelithiate the composite particles prior to forming the electrodes.

Electrochemical Preionization. Alternatively, Electrochemical Preioinization may be used. For example, electrochemical prelithiation of coin cells may be accomplished as assembled in a half-cell configuration. Cell composition is as follows: coin cell casing bottom, lithium chip, separator, electrode, spacer, spring, coin cell casing top. The coin cells are then crimped to seal. Cells are left to rest for (6) hours on the tester before a current of C/20 (based on the theoretical capacity of battery grade graphite) is applied to the cell for initial lithiation of the electrode. Lithiation continues until the potential between the electrode and the lithium chip reaches 0.005 Volts. Then, the cell may undergo a rest period to normalize. The cell may be de-lithiated to 0.6 Volts at the same rate as previously determined, until a preferred threshold voltage is reached in the charge/discharge cycles. For example, a current may be continually applied at the preferred threshold voltage until the current drops to a specified value (e.g. C/50) value. After cycling, the half cell was de-crimped, and the prelithiated electrode was assembled into a full cell with a matching cathode electrode for testing to determine electrochemical performance.

Direct Chemical Prelithiation (DCP). Electrodes that are candidates for DCP are first “pre-assembled” in split cells. The coated surface of the electrode and lithium are in direct contact with each other, and a liquid medium is introduced to facilitate a “passive” diffusion of ions from the lithium chip to the electrode. Factors such as time, temperature, and pressure are tunable parameters that may affect the degree of prelithiation. After the electrode has undergone what is determined to be sufficient pre-lithiation, it may be carefully removed, dried, assembled in a full cell battery configuration with a matching cathode, and subsequently tested.

Lithium Doping Pretreatment. A measured amount of prelithiation “solution” is pipetted onto the surface of a punched electrode. Solvent is allowed to evaporate and deposit lithium particles in/on the electrode. The electrode is assembled in a full cell battery configuration with a matching cathode, and subsequently tested.

For example, FIG. 6 illustrates a flow diagram for creating composite particles having a spherical shape. In one example, the process starts with a slurry of particles and a polymer derived ceramic (PDC) precursor. The precursor may be a curable resin. For example, the resin may be one of the resins described in copending U.S. application Ser. No. 17/941,697, the entirety of which is hereby incorporated by reference. The particles may comprise a single type of particle or a plurality of different particle types, such as particles, fibers, nanotubes or the like, which may be comprised of one or a combination of carbon, metals, oxides, nitrides or the like. The process may proceed from the first step to the last step or, as suggested by the process control lines, a step in the process may be repeated more than once. For example, it has been found that creating spheroidal particles improves properties of electrodes. All of the electrical properties of an electrode are improved by making the composite particles more spherical.

In one example, a dispersion process is carried out. The dispersion process provides an emulsion that captures a plurality of particulates in a PDC resin as illustrated in FIG. 8, for example. For example, an overhead mixer may use a high-shear dispersion-type blade or an impeller-type blade for creating an emulsion of spherical droplets. By spherical, it is not meant to suggest that the particles are all perfect spherics, but in comparison with other processes, the emulsification process produces more spherical particles. More spherical composite particles produce electrodes with improved performance when incorporated into ion batteries when compared to less spherical particles. The spherical particles may comprise spherical resin or resin/carbon composite. The emulsion comprises a plurality of spherical particles that are suspended in a carrier solution, such as a water/surfactant carrier solution. As an alternative to using a surfactant or in addition to use of a surfactant, sonication may be used to control the size of the spherical particles suspended in the carrier fluid. For example, ultrasonication of a resin/carbon/surfactant mixture may be employed at 20 kHz of ultrasonic rates/frequencies are utilized to further improve the dispersion and/or reduce the resin droplet size. Following complete dispersion and emulsion formation, the temperature of the emulsion may be increased to 35-40 degrees Celsius to initiate thermal curing of the pre-ceramic PDC polymer resin. For example, the emulsion may be held at temperature for 2-24 hours. Preferably, the duration allows for complete gelation of the PDC polymer resin. Stirring of the emulsion may be maintained throughout the curing process. After the step of curing, heat may be removed/turned off and stirring may be stopped. Then, as the solution cools, some of the cured resin particles settle out of the carrier fluid. The carrier fluid may be decanted and settled-out particles may be collected and dried. For example, drying may be expedited using a solvent that evaporates at ambient temperature and pressure or by heating and/or using vacuum pressure to dry the cured resin particles. The decanted carrier fluid may be processed to remove finer particles that did not settle out of the emulsion carrier fluid. These fine particles may be collected by any one or a combination of centrifugation, filtration, and evaporation of the carrier liquid. Particles that are dried may undergo further curing by heating in an oven at a temperature selected from 120 to 160 degrees centigrade, which may be performed in an inert atmosphere or in air. The dried and/or further cured particles may have agglomerated but are separated into spherical particles by milling. For example, mechanical grinding in a coffee grinder-type machine may be sufficient to break up any agglomerates/fused particles that may have formed within the emulsion forming, initial curing, separation or secondary curing steps. By obtaining separated, spherical plastic-phase particles, prior to pyrolysis, the electrical properties of an electrode made from the particles. The cured particles are heated to pyrolysis temperatures in an inert-atmosphere furnace to convert plastic phase to ceramic phase. Following pyrolysis, the particles undergo further grinding and/or milling to break up any agglomerates that form during pyrolysis. Pyrolysis results in the production of spherical, ceramic-phase particles that may be formed into an electrode with exceptional properties.

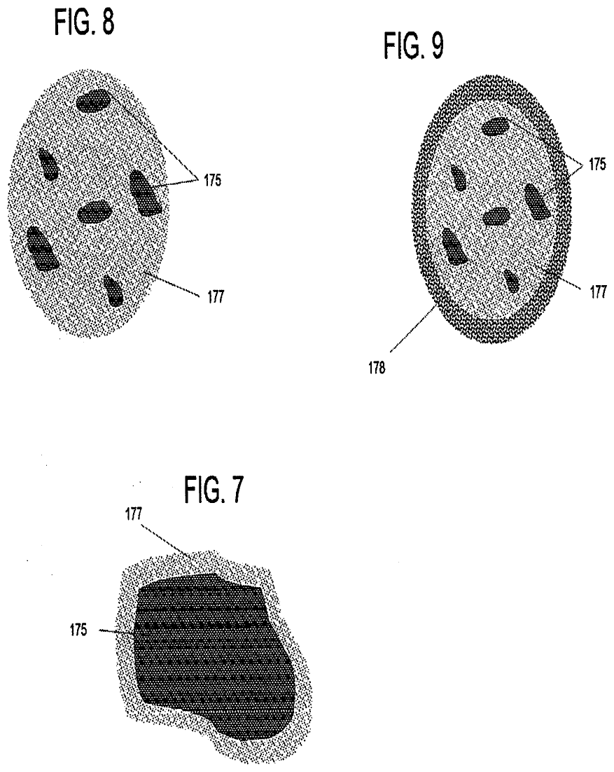

FIG. 7 illustrates an example of a nonspherical cross section of a particle 175 coated by a polymer derived ceramic precursor 177. If pyrolyzed, the particle 175 remains non-spherical and fails to provide suitable properties when formed into an electrode with other non-spherical particles, when the plurality of non-spherical particles are incorporated as an anode into an ion battery, such as a lithium ion battery.

FIG. 8 illustrates an example of one or more particles 175 being assembled into a spherical composite particle. Again, the polymer resin 177 coats the particles 175, but the process is controlled to produce particles having a spherical cross section, such as by emulsion processing, as described in relation to FIG. 6, for example. In this example, the composite particle is comprised of a single PDC resin and a plurality of particles, and the particles may be of one or more types of particles. Preferably, the plurality of particles comprises bio-derived carbon particles.

FIG. 9 illustrates another example of a cross section showing a plurality of particles 175 being assembled into spherical composite particles using a polymer resin 177. In this example, an additional shell 178 is added to the particle that produces particles that are even more spherical with resulting better properties. The shell 178 may be added using the same or a different PDC resin. The first resin 177 may be selected to be compatible with bioderived carbon particles, for example. While a spherodizing outer coating may be selected for the shell 178 that may be of a different PDC resin or composite. In one example, the shell 178 is a composite of a PDC resin and a bioderived carbon, preferably a bioderived polysaccharide that is preprocessed into a fine powder carbon source for mixture with a compatible PDC resin. For example, the process may use emulsification for forming the inner core particles. Then, the inner core particles may be heated in the emulsifying liquid at a temperature capable of resulting in gelation, such as by crosslinking or other chemical reactions, of the composite PDC resin-carbon inner core. These inner core particles may be dried and pyrolyzed or may be dried and cured at a temperature less than the temperature for pyrolyzing the inner core particles. The latter particles may be preferable for the next step, when the outer shell is added to the inner core. Regardless, the inner core particles are separated by milling prior to re-emulsification or a solvent coating process that coats the inner core particles with the outer shell. In one example, the outer shell is a composite of a bioderived carbon source that is finely ground and a compatible PDC resin, such as one of the resins described in copending U.S. application Ser. No. 17/941,697, preferably with divynilbenzene. The resulting composite particles may be cured at a soft curing temperature, a hard curing temperature or a combination thereof by first using a soft curing temperature, a separating process, such as milling or ultrasound, and a hard curing temperature. Regardless, the particles may be separated using a separating process prior to pyrolysis of the particles.

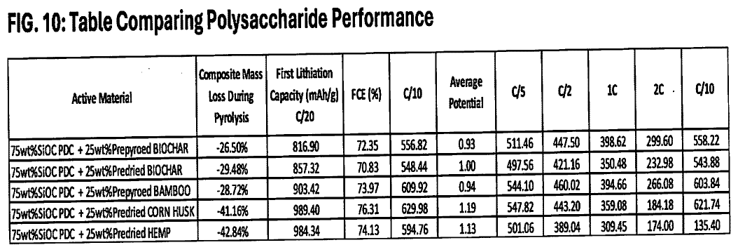

FIG. 10 is a comparison of polysaccharides prepared either by precarbonizing, pre-pyrolysis, and/or predrying. The addition of polysaccharides shows improved performance when combined in compatible PDC resins used in electrodes as provided in the examples. Biochar provided comparatively disappointing results compared to the other sources of polysaccharides. Pre-pyroed means that heating extended beyond drying and at higher temperatures. However, pre-pyroed polysaccharides were likely not pyrolyzed to completion. Significant weight loss was observed even after these post-drying steps. For this reason, it is thought that the polysaccharides were not carbonized and retained some hydrocarbons prior to mixing with compatible PDC resins. The results from FIG. 10 show that polysaccharides that are not suitable for other uses and may be considered waste are suitable for use as a renewable source of carbon in battery electrodes, when combined with a compatible PDC according to the examples provided herein.

This detailed description provides examples including features and elements of the claims for the purpose of enabling a person having ordinary skill in the art to make and use the inventions recited in the claims. However, these examples are not intended to limit the scope of the claims, directly. Instead, the examples provide features and elements of the claims that, having been disclosed in these descriptions, claims and drawings, may be altered and combined in ways that are known in the art.

What is claimed is:

1. A method for making a ceramic composite electrode comprises:
selecting a bioderived carbon compatible with a polymer derived ceramic resin, wherein the carbon material of the bioderived carbon is derived from a biological source;
mixing the bioderived carbon with the polymer derived ceramic precursor to form a mixture of the bioderived carbon and the polymer derived ceramic precursor; and
pyrolyzing the mixture such that the mixture forms a silicon oxycarbide (SiOC) ceramic composite in the form of an electrically conductive ceramic composite electrode of a battery.

2. The method of claim 1, wherein the bioderived carbon is dried at a temperature, prior to the step of mixing, such that the resulting bioderived carbon is a porous graphitic carbon having optimal specific surface area regions within the electrically conductive ceramic composite electrode of the battery.

3. The method of claim 2, further comprising a step of milling the electrically conductive ceramic composite to form a power and forming the powder into the electrically conductive ceramic composite electrode of the battery.

4. The method of claim 1, wherein the polymer derived ceramic precursor is a resin comprised of silicon, oxygen and carbon.

5. The method of claim 4, wherein the polymer derived ceramic precursor is comprised of a silicon oxycarbide, silicon carbon nitride, silicon titanium oxycarbide, silicon aluminum oxycarbide, silicon-aluminum oxynitride, silicon carbide or mixtures thereof.

6. The method of claim 5, wherein the polymer derived ceramic precursor is comprised of silicon oxycarbide.

7. The method of claim 1, further comprising a step of macerating the bioderived carbon prior to the step of mixing.

8. The method of claim 7, further comprising at least partially precarbonizing the bioderived carbon after the step of macerating and prior to the step of mixing.

9. The method of claim 1, further comprising the steps of:
milling the electrically conductive ceramic composite to form a power; and
prelithiating the powder to form a prelithiated composite anode of a lithium ion battery.

10. The method of claim 9, wherein the prelithiated composite anode comprises activated sites for attachment of lithium ions.

11. The method of claim 9, wherein the prelithiating comprises forming the powder into an anode and precycling the anode through repeated charge-discharge cycles to form the prelithiated composite anode of the lithium ion battery.

12. The method of claim 11, wherein the anode after the step of precycling is removed and a step of reforming is performed to form the prelithiated composite anode of the lithium ion battery.

13. The method of claim 1, further comprising the steps of:
milling the electrically conductive ceramic composite to form a power; and
pre-sodiating the powder to form a pre-sodiated composite anode of a battery.

14. The method of claim 13, wherein the pre-sodidated composite anode comprises activated sites for attachment of sodium ions.

15. The method of claim 9, wherein the pre-sodiation comprises forming the powder into an anode and precycling the anode through repeated charge-discharge cycles to form the pre-sodiated composite anode of the battery.

16. The method of claim 11, wherein the anode after the step of precycling is removed and a step of reforming is performed to form the pre-sodiated composite anode of the battery.

17. The method of claim 1, further comprising preparing polysaccharides as the source of carbon for the bioderived carbon.

18. The method of claim 17, wherein the polysaccharides are a waste product that would otherwise incur costs for disposal.

19. The method of claim 1, wherein the step of selecting includes selection to obtain oxygen-containing functional groups from a list of functional groups including hydroxyl, carbonyl, carboxyl groups and combinations thereof being created after the step of pyrolyzing.

20. The method of claim 1, further comprising a step of hydrothermal carbonization of the bioderived carbon prior to the step of mixing.
